(19) United States
(12) Patent Application Publication
(10) Pub. No.: US 2025/0355625 A1
(43) Pub. Date: Nov. 20, 2025

(54) EFFICIENT FIXED-POINT DIGITAL LOGIC HARDWARE FOR HIGH-PRECISION COMPUTATION

(71) Applicant: INTERNATIONAL BUSINESS MACHINES CORPORATION, ARMONK, NY (US)

(72) Inventors: Elena Ferro, Adliswil (CH); Irem Boybat Kara, Adliswil (CH); Athanasios Vasilopoulos, Zurich (CH); Manuel Le Gallo-Bourdeau, Horgen (CH); Abu Sebastian, Adliswil (CH)

(21) Appl. No.: 18/665,515

(22) Filed: May 15, 2024

(51) Int. Cl. G06F 7/523; G06F 5/01; G06F 7/50

(52) U.S. Cl. CPC G06F 7/523; G06F 5/01; G06F 7/50

(57) ABSTRACT

A computer-implemented method and device performing digital post-processing of an in-memory computing crossbar array. The computer-implemented method includes providing a digital computing block positioned at a periphery of the in-memory computing crossbar array. The digital computing block is configured to perform fixed-point computations of an input, compression on the fixed-point computations of the input; and a nonlinear activation function.

### BACKGROUND

### Technical Field

The present disclosure is generally related to computer structures that may be used in Artificial Intelligence (AI) applications, and more particularly to analog in-memory computing (AIMC) devices and methods for high-precision computations in applications including, but not limited to, AI.

### Description of the Related Art

Analog in-memory computing (AIMC) is a promising approach to perform matrix-vector-multiplication (MVM) with very high efficiency and low latency. Since the processing of data in AIMC is highly parallelizable, the ideal solution is to have one near-in-memory digital logic per crossbar (xbar) column. However, the pitch of AIMC columns is very small and is a significant constraint for the area of such logic.

As a consequence, to sustain AIMC energy efficiency and low latency, a small, fast, energy-efficient and accurate near-in-memory digital logic is desirable to perform affine corrections on the output of the xbar.

### SUMMARY

According to an embodiment, a computer-implemented method and device performs digital post-processing of an in-memory computing crossbar array. The computer-implemented method includes providing a digital computing block positioned at a periphery of the in-memory computing crossbar array that includes instructions to execute fixed-point computations of an input, compression on the fixed-point computations of the input; and a nonlinear activation function.

### BRIEF DESCRIPTION OF THE DRAWINGS

The drawings are of illustrative embodiments. They do not illustrate all embodiments. Other embodiments may be used in addition to or instead. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps.

FIG. 1 illustrates an in-memory crossbar, consistent with an illustrative embodiment.

FIG. 2A is a flowchart illustrating an implementation of an efficient parametrizable digital computing block, consistent with an illustrative embodiment.

FIG. 2B is a flowchart illustrating a fixed-point quantization method, consistent with an illustrative embodiment.

FIG. 3 is a flowchart illustrating a digital computing block having differential inputs and multiple branches, consistent with an illustrative embodiment.

FIG. 4A is a flowchart illustrating an implementation of a near-in-memory digital computing logic block consistent with an illustrated embodiment.

FIG. 4B is a flowchart of a method for performing design space exploration consistent with an illustrative embodiment.

FIG. 5 illustrates a block diagram of a computing environment to perform digital post-processing of an in-memory computing crossbar array by a digital computing block, consistent with an illustrative embodiment.

### DETAILED DESCRIPTION

In the following detailed description, numerous specific details are set forth by way of examples to provide a thorough understanding of the relevant teachings. However, it is to be understood that the present teachings may be practiced without such details. In other instances, well-known methods, procedures, components, and/or circuitry have been described at a relatively high-level, without detail, to avoid unnecessarily obscuring aspects of the present teachings. It is also to be understood that the present disclosure is not limited to the depictions in the drawings, as there may be fewer elements or more elements than shown and described.

Although the terms first, second, etc., may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

As used herein, the term “parametrizable” refers to the use of tunable parameters that would have been regarded as unalterable constants.

As used herein, “affine correction” refers to a compensation for imperfections in memory devices that are related to non-idealities, and for circuit mismatches in the ADCs. Circuit mismatches and non-idealities in ADCs and memory devices are a cause of errors in the output data. The affine correction provides for more accurate results in subsequent processing steps.

As used herein, “in-memory computing” arranges computation tasks near or inside the memory.

As used herein, “near-memory computing” includes having some processing functions close to the memory, resulting in reduced data movement and enhanced system efficiency.

As used herein, “precision” refers to the number of bits used to represent the numbers.

Moreover, the term “high-precision” refers to a description that the number of bits substantially matches an expected outcome. In high-precision, a large number of bits are adopted for the multiplication (scale operation). Having this high-precision (high number of bits) for the multiplication results in more accurate results.

As used herein, the term “shift operation” ensures that the number fits the desired number of bits.

As used herein, a cut and round operation can be performed in a number of ways that include but are not limited to rounding when the MSB of the LSB bits to cut is 1, or the rounding is based on the LSB.

### Support

In an embodiment, a computer-implemented method performs digital post-processing of an in-memory computing crossbar array. The computer-implemented method includes providing a digital computing block positioned at the periphery of the in-memory computing crossbar array that includes instructions to execute fixed-point computations of an input, compression on the fixed-point computations of the input; and a nonlinear activation function.

In an embodiment, which may be combined with the preceding embodiment, the computer-implemented method includes performing a plurality of the fixed-point computations in parallel on respective outputs of the in-memory computing crossbar array.

In an embodiment, which can be combined with one or more preceding embodiments, the computer-implemented method includes performing affine scale and offset correction to the fixed-point computations.

In an embodiment, which can be combined with one or more preceding embodiments, the computer-implemented method includes providing that the digital computing block is customized based on different sizes of the input, different sizes of the affine scale and offset correction including integer precision and fractional precision, and different sizes of fixed-point compression parameters regarding a number of bits to cut before and after rounding.

In an embodiment, which can be combined with one or more preceding embodiments, the computer-implemented method includes parameterizing the digital computing block to process one entry of the input at a time as an N-bit unsigned input by a crossbar of the in-memory computing crossbar array, wherein N is a number of data bits.

In an embodiment, which can be combined with one or more preceding embodiments, the computer-implemented method includes providing the digital computing block with a plurality of sub-blocks configured to perform operations including multiplication, sum for an offset, shifting, and fixed-point quantization.

In an embodiment, which can be combined with one or more preceding embodiments, the multiplication operations are performed by a multiplier sub-block by applying a scale parameter to the N-bit unsigned input and outputting a high-precision number including N+X bits for an integer part and Y bits for a fractional part.

In an embodiment, which can be combined with one or more preceding embodiments, the shifting operations are performed by a shifting sub-block that verifies the output of the multiplier sub-block fits a desired precision with regard to a number of bits.

In an embodiment, which can be combined with one or more preceding embodiments, the fixed-point quantization operations are performed by a fixed-point quantization sub-block that reduces the precision of data output by the shifting sub-block.

In an embodiment, which can be combined with one or more preceding embodiments, the fixed-point quantization sub-block reduces the precision of data output by the shifting sub-block via cutting one or more least significant bits (LSB) and/or one or more most significant bits (MSB).

In an embodiment, which can be combined with one or more preceding embodiments, the fixed-point quantization sub-block additionally reduces the precision of data output from the shifting sub-block by performing rounding, and checking an overflow after rounding.

In an embodiment, which can be combined with one or more preceding embodiments, the fixed-point quantization sub-block performs rounding when the MSB of the cut LSB bits is 1.

In an embodiment, which can be combined with one or more preceding embodiments, the computer-implemented method includes generating a signed output of the fixed-point quantization sub-block by performing a 2's complement operation.

In an embodiment, a computer-implemented method of performing digital post-processing of a near-in-memory computing logic includes processing one or more entries across a plurality of clock cycles, wherein each entry comprises two multi-bit unsigned integers corresponding to positive and negative outputs of an Analog-to-Digital (ADC) converter. The two multi-bit unsigned integers are multiplied in parallel with a scale parameter, and a shifting operation of an output of each multiplied two multi-bit unsigned integers is performed to ensure the output of each multiplied two multi-bit unsigned integers fits a desired precision. An overflow check is performed to verify whether there is an overflow after the multiplying operation of the two multi-bit unsigned integers to determine whether a result of the multiplying operation needs to be saturated to a maximum representable value with a specified precision. A fixed-point compression algorithm is performed to reduce a size of the result of the multiplying operation.

In an embodiment, which can be combined with the preceding embodiment, the processing of the one or more entries includes time-multiplexing across the plurality of data cycles. The performing of the fixed-point compression algorithm reduces the size of the result of the multiplying operation by truncating one or more of a most significant bit (MSB) and one or more of a least significant bit (LSB). There is a checking of a value of a round bit. Upon determining the value of the round bit is 0, truncating the bits without rounding; and upon determining the value of the round bit is 1, rounding up prior to truncating the bits.

In an embodiment, which can be combined with the one or more of the preceding embodiments, providing the digital computing block is based on defining a search space by creating a parametric model of the digital computing block. The digital computing block is configured with a chip simulator with regards to a bit-size of parameters of inputs and a fixed-point quantization operation. Configurations of the defined search space are iteratively evaluated to identify a performance of one or more configurations in terms of accuracy. The one or more configurations are synthesized to determine a highest-ranked accuracy. The digital computing block is provided according to fitting design constraints of the one or more configurations and/or by performance in terms of energy efficiency.

In an embodiment, a digital-computing block for an in-memory computing includes a plurality of sub-blocks configured to perform operations including multiplication, sum for an offset, shifting, and fixed-point quantization. The digital computing block is positioned at the periphery of an in-memory computing crossbar array.

### Overview

Analog In-Memory Computing (AIMC) methods and devices operate in a way that utilize the physical properties of memory devices to perform both data storage and data computation at the same physical location. Whereas in digital computing the data is transported between a central processing unit (CPU) and a memory, in AIMC the data is directly stored and processed in a system memory. Advantages of the use of AIMC include the data is stored in the system memory, and that the data may be processed directly into the memory itself, overcoming the memory wall issues typical of digital computing.

The direct data storage reduces latency and improves energy efficiency. The improved latency is especially valuable when executing artificial intelligence (AI) applications. The industry seeks efficient chips with high performance (e.g., 100 TeraOPS/Watt), for data movement optimization.

Near-memory architectures can be used for various applications, including neural networks and data processing. However, to execute Artificial Intelligence (AI) applications, AIMC operates with pre-processing and post-processing of the data. Affine correction is used to limit the non-linearity and resistance drift effect of the devices, and to compensate for the gain and offset variations of the Analog-to-Digital Converters (ADCs). Additionally, subsequent simple neural networks (NNs) element-wise operations need to be supported. In order to sustain the high energy efficiency and low latency of such systems it is desirable to design efficient near-in-memory digital logic to support such operations.

Since the processing of data in AIMC is highly parallelizable, the ideal solution is to have one near-in-memory digital logic per xbar column. However, the pitch of AIMC columns is very small and this implies a significant constraint for the area of such logic.

The present disclosure is generally directed to a method and an apparatus to execute power-efficient fixed-point digital logic for high-precision computation to support AIMC systems. The fixed-point digital logic includes fixed-point number formats for each stage that are parametrizable. In addition, the design of the fixed-point digital logic minimizes the precision loss compared to high-precision computation (e.g., FP16/FP32).

According to the present disclosure, an implementation of an efficient parametrizable digital computing block processes one entry at a time (a number “N” of bits “b” of an unsigned input) and performs scale and offset exploiting fixed-point precision computations and quantization.

The digital computing block is generalized for any of the different sizes of the inputs, different sizes of the scale and offset precision, including integer precision and fractional precision, and different sizes of fixed-point compression parameters (e.g., a number of bits to cut before rounding; which bits are used to define if a rounding operation is performed).

In an illustrative embodiment, the digital block is made of different sub-blocks. For example, there may be provided a multiplier block, an adder block, a shift block, and a fixed-point quantization block.

For example, with regard to the multiplier block, the process includes applying the scale parameter to the input and output high-precision number (N+X for the integer part and Y for the fractional part). With regard to the shifting block, the process includes ensuring that the result of the multiplication by the multiplier block fits in the desired precision. With regard to the fixed-point quantization block, the precision of the data may be reduced from (N+X, Y) to (N+X−P,Y−Q−R), where N is a number of data bits, X is a number of bits for an integer part of a scale parameter, Y is a number of bits for a fractional part of a scale parameter, P is a number of MSB to cut, and Q+R is a number of LSB to cut, Y−Q−R is a maximum number of bits for the fractional part after quantization, and N+X-P+Y−Q−R is the maximum number of bits that determines the value of the overflow: 2**[(N+X−P+Y−Q−R)]−1.

The embodiments of the present disclosure provide for an improvement in the operation of a computer-based on reduced processing power requirements, area and latency. In addition, in the field of data processing, there is an improvement resulting in a more accurate processing of the data.

### EXAMPLE EMBODIMENT(S)

It is to be understood that some of the advantages of the present disclosure are provided herein below. However, a person of ordinary skill in the art will appreciate that additional advantages may exist in addition to those described herein.

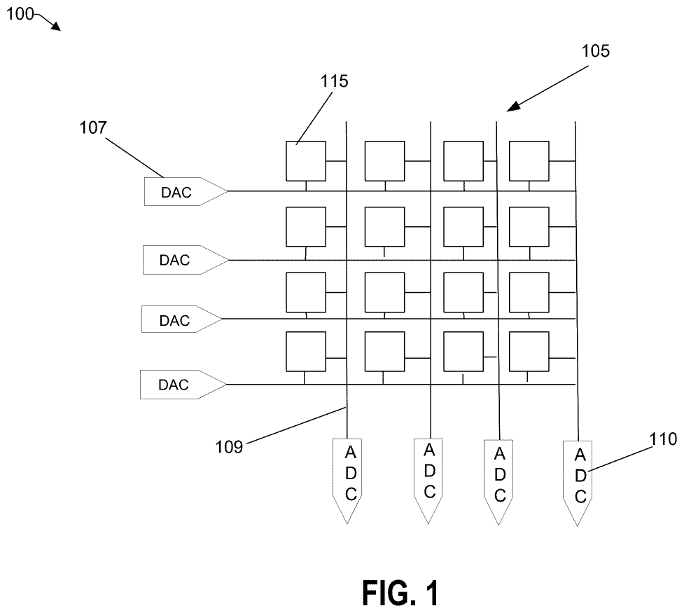

FIG. 1 is an overview 100 of an in-memory crossbar 105, consistent with an illustrative embodiment. FIG. 1 shows a mixed signal in-memory crossbar where digital-to-analog converters (DAC) 107 convert digital inputs into an analog signal that is provided to the memory cell 115. The in-memory crossbar 105 may include additional programming circuits and control circuits. The memory cell 115 stores a kernel value of a computed layer. A summation line 109 accumulates an output (e.g., result) signal representing an operation result. Analog-to-Digital converters (ADC) 110 convert the result back to a digital signal that may be output to other components for additional processing. The in-memory crossbar 105 can be complemented by an efficient digital compute block employing fixed-point precision computation along with an accurate quantization scheme to reduce a number of bits of the processed output data after high-precision computations. This structure provides a special-purpose digital computing logic for area, latency and power-efficient implementation of affine correction and batch normalization (BN) while being able to minimize the loss in terms of accuracy compared to the equivalent implementation in FP16 (or FP32).

### Example Processes

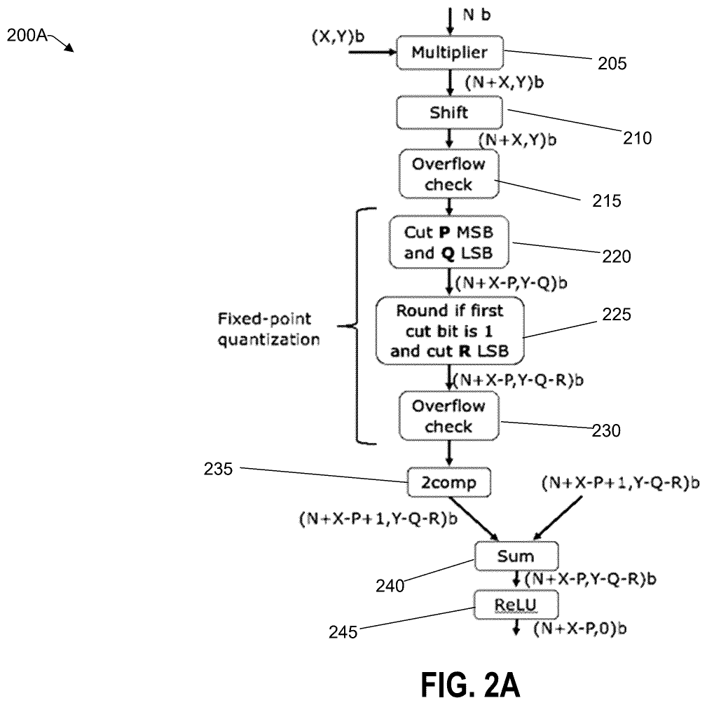

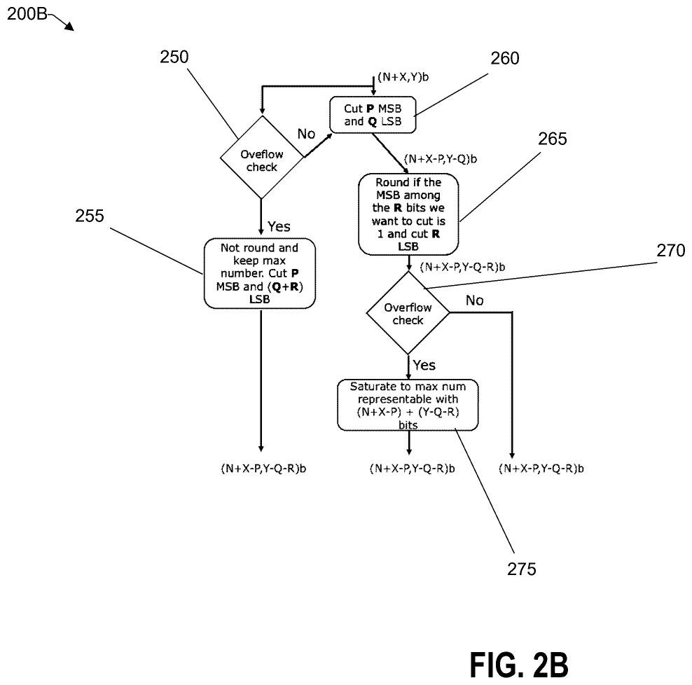

With the foregoing overview of the example architecture, it may be helpful now to consider a high-level discussion of exemplary processes. To that end, FIGS. 2A through 4 are flowcharts illustrating a computer-implemented method consistent with an illustrated embodiment.

FIG. 2A is a flowchart 200A illustrating an implementation of an efficient parametrizable digital computing block, consistent with an illustrative embodiment. More particularly, the flowchart 200A illustrates an implementation of an efficient parametrizable digital compute block that processes 1 entry at a time (Nb unsigned input) and performs scale and offset exploiting fixed-point precision computation.

There is first shown a multiplier operation to apply the scale parameter to the input and output high precision number (N+X for integer part and Y for fractional) on (operation 205). The input may be a signed input or an unsigned input. A shift operation ensures that the result of the multiplication fits in the desired precision (operation 210). An overflow check is performed to determine if the result exceeds a maximum representable value and where there is a carry bit (operation 215).

Still referring to FIG. 2A, fixed-point quantization is performed by the fixed-point quantization sub-block of the digital computing block. Fixed-point quantization reduces the precision of the data from (N+X, Y) to (N+X−P, Y−Q−R). The steps include cutting some MSB and few LSB (P and Q+R respectively) (operation 220). A rounding operation occurs depending on the round bit. For example, if the first bit of the R LSB to cut is 1, then a rounding is performed (operation 225). The next operation is to check the overflow after rounding (operation 230), and to perform a 2's complement conversion to generate a signed output (operation 235). A summing operation to apply the offset parameter to the scaled input is performed (operation 240) and then a nonlinear activation function (Rectified Linear Unit, e.g., ReLU) is performed (operation 245).

FIG. 2B is a flowchart 200B illustrating a fixed-point quantization method, consistent with an illustrative embodiment. The digital computing block is generalized for different sizes of the inputs, different sizes of the scale and offset precision, including integer precision and fractional precision, and different sizes of fixed-point compression parameters (i.e. number of bits to cut before rounding; which bits are used to define if a rounding operation is performed). With an input (N+X, Y) b output from the multiplier sub-block, there is a cutting of P (an MSB) and Q (an LSB) (operation 260). An overflow check is performed (operation 250), and if there is an overflow, then rounding is not performed and P (MSB), (Q+R) LSB are cut (operation 255). If there is no overflow (operation 250), then there is a rounding operation if the MSB among R LSB bits is 1 and cut R LSB (operation 265). Another overflow check occurs (operation 270). If there is no overflow then the output is (N+X−P, Y−Q−R) b. If there is an overflow, it is determined there is a saturate to maximum number representable with (N+X−P)+ (Y−Q−R) bits.

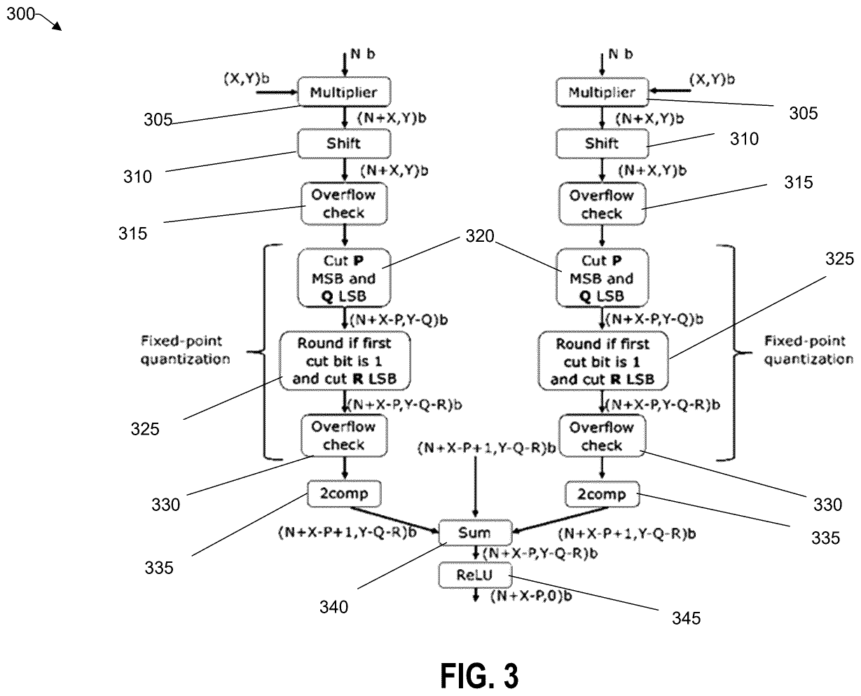

FIG. 3 is a flowchart 300 illustrating a digital computing block having differential inputs and multiple branches, consistent with an illustrative embodiment. The digital computing block can be expanded in a scenario where differential inputs are involved. In such cases, each input includes a combination of two N-bit unsigned integers (N b) which are processed simultaneously in two different branches.

The two entries are multiplied with a scale parameter (operation 305) and shifted (operation 310) to ensure the results can fit the desired precision. At this step there is an overflow check (operation 315) to ensure there is no overflow after multiplication and in the affirmative case, the result is saturated to the maximum representable value within the specified precision.

The novel fixed-point compression method of the present disclosure is applied in order to reduce the size. This compression is done in different steps, where first the P MSB and Q LSB are truncated (operation 320), then, if there was no previous overflow, the round bit is checked and if it is 1 we round up before cutting (operation 325) while if it is 0, then just cut R bits. If there was already an overflow, the value is kept as the maximum value representable with the defined precision. The last step is to check if the rounding generates an overflow (operation 330) and in that case, the value is saturated to be the maximum representable value with the defined precision. A 2's complement is performed (operation 330) to generate a signed value that is summed (operation 340) from both branches and the offset and a nonlinear activation function (ReLU) is performed (operation 345).

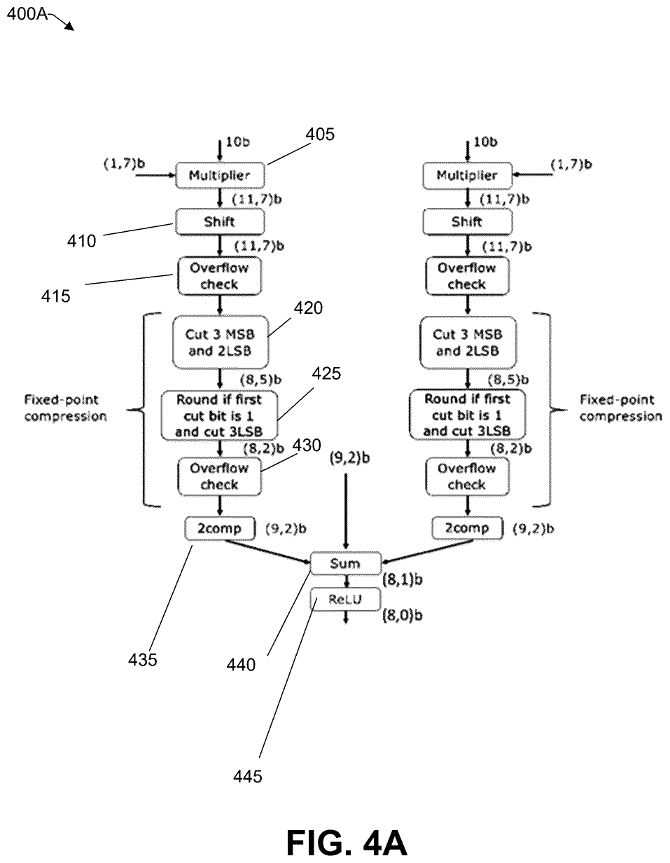

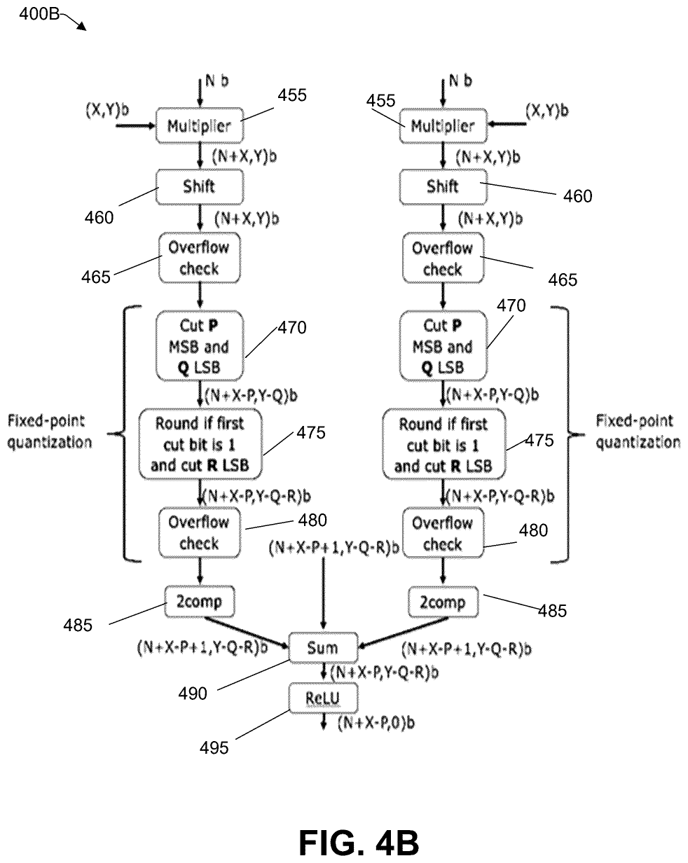

FIG. 4A is a flowchart 400 illustrating an implementation of a near-in-memory digital computing logic block consistent with an illustrated embodiment. The digital computing block can be extended to the implementation of an efficient near-in-memory compute logic block that processes 4 entries, time-multiplexed across 4 clock cycles (4 ns). Each entry is made of two 10b unsigned integers which correspond to the ADCs' positive and negative outputs and are handled in parallel on two distinct branches.

First the two entries are multiplied (operation 405) with a scale parameter and shifted (operation 410) to ensure the results can fit the desired precision. A first overflow check (operation 415) is performed to ensure there is no overflow after multiplication and in the affirmative case, the result is saturated to the maximum representable value with the specified precision.

The novel fixed-point compression method according to the present disclosure is applied to reduce the size. This compression is done in different steps where first the 3 MSB and 2 LSB are truncated (operation 420), then, if there was no previous overflow, the round bit is checked and if it is 1 we round up before cutting while if it is 0 then just cut the bits (operation 425). If there was already an overflow, the value is kept as the maximum value representable with the defined precision. The last step is to check if the rounding generates an overflow (second overflow check operation 430) and in that case, the value is saturated to be the maximum representable value with the defined precision. A 2's complement is performed (operation 435) to generate a signed value that is summed (operation 440) from both branches and an offset and a nonlinear activation function (ReLU) is performed (operation 445).

It is to be understood that an output of an ReLU is a maximum value between zero and an input value. An output of an ReLU is equal to zero when the input value is negative, and the output of an ReLU is the input value when the input is positive.

FIG. 4B is a flowchart of a method for performing design space exploration consistent with an illustrative embodiment.

By using a chip/simulator-in-the-loop, the digital unit according to the present disclosure is highly configurable with regards to bit-size of parameters/inputs and the fixed-point quantization steps.

The definition of these parameters occurs in the context of the use-case of the system. For example, in the context of AIMC, the ADCs transfer curves can be used to estimate the maximum and minimum values required for the scale and offset computation, allowing for a minimum number of bits for such parameters and, consequently, for a more compact and energy-efficient design for the specific system.

A parametric model of the unit is created such as shown in FIG. 4B and a search space is defined (for the combination of parameters that are “valid and useful”). In general, some of the parameters depend on the system under consideration and some of the parameters may assume certain values or others. For example, in the context of AIMC, if we have ADCs and the input of the proposed block is the output of the ADCs, there is no point to consider large number of bits for the input (N) because of the ADCs behavior whose area significantly increases with the number of bits on the output. In another example, if there are a certain number of bits of the input and the output, the number of bits to cut and the different cut/round methodologies that can be taken into consideration depend on these ranges.

A benchmark suite and evaluation criterion is defined for the precision of the unit. This step can be tailored to a number of critical applications (i.e. accuracy on certain networks) or general to cover a general-use system (precision across a diverse benchmark suite).

Using a chip-in-the-loop or simulator-in-the-loop approach, the selected criterion in the benchmarks are evaluated in realistic operating conditions. Any chip similar to the one explored in the design can be used as long as ADC data are able to be extracted,

Realistic simulators can be used in the absence of an analog in-memory computing chip. These simulators can be used at the circuit level (e.g., SPICE®) or with high-level models that capture AIMC non-idealities (e.g., AIHWKIT®)

Iteratively, the configurations of the search space are evaluated to determine the best performing configurations in terms of accuracy. The best performing configurations are synthesized, and a digital unit is selected that fits the design constraints or outperforms the field in terms of area and energy efficiency.

For example, with reference to FIG. 4B, there are two entries that are multiplied (operation 455) with a scale parameter and a shift (operation 460) performed to ensure the results can fit the desired precision. An overflow check is performed to ensure there is no overflow after multiplication (operation 465). In the affirmative case, the result is saturated to the maximum representable value with the specified precision. These operations are similar to the descriptions of the flowchart of FIG. 4A.

Fixed point quantization is then performed that includes cutting the P MSB and Q LSB (operation 470), rounding if the bit cut is 1, and cut R LSB (operation 475), and a second overflow check (operation 480).

A 2's complement is performed (operation 485) to generate a signed value that is summed (operation 490) from both branches and an offset, shown in FIG. 4B. A nonlinear activation function (ReLU) is performed (operation 495).

### Computing Environment

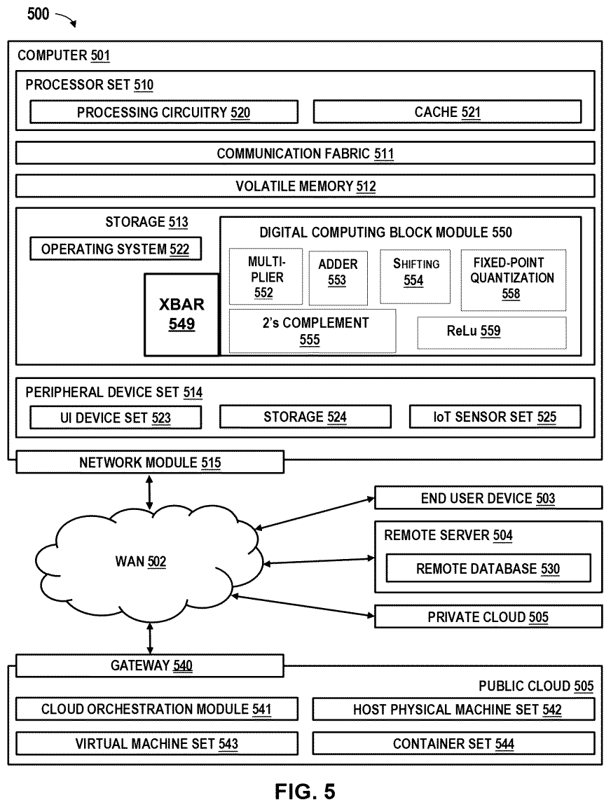

FIG. 5 illustrates a block diagram of a computing environment to perform digital post-processing of an in-memory computing crossbar array by a digital computing block, consistent with an illustrative embodiment.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored. Such components in the computing environment 500 may be in communication with the in-memory or near in-memory digital computing logic consistent with an illustrative embodiment of the present disclosure.

With reference to FIG. 5, the computing environment 500 includes an example of an environment for the operation of a digital computing block module 550 execution of at least some of the computer code involved in performing the inventive methods. In an embodiment, the digital computing block module 550 is positioned at the periphery of a crossbar 549. Computer-executable instructions in the digital computing block module 550 control operations of the multiplier sub-block 552, an adder sub-block 553, shifting sub-block 554, fixed-point quantization sub-block 558, 2's complement sub-module 555, and a Rectified Linear Unit (ReLU) 559. The multiplier sub-block 552 applies a scale parameter to an N-bit unsigned input and outputs a high-precision number including N+X bits for an integer part and Y bits for a fractional part. The shifting sub-block 554 performs a verification that the output of the multiplier sub-block 552 fits a desired precision with regard to a number of bits. The 2's complement sub-module 555 generates a signed output of the fixed-point quantization sub-block 558 that reduces the precision of data output by the shifting sub-block 554 via cutting one or more least significant bits (LSB) and/or one or more most significant bits (MSB). The ReLU 559, as described herein above, performs non-linear activation functions.

In addition, computing environment 500 includes, for example, computer 501, wide area network 502 (WAN), end user device 503 (EUD), remote server 504, public cloud 505, and private cloud 506. In this embodiment, computer 501 includes processor set 510 (including processing circuitry 520 and cache 521), communication fabric 511, volatile memory 512, storage 513 (including operating system 522 and the digital computing block module 550, as identified above), peripheral device set 514 (including user interface (UI) device set 523, external storage 524, and Internet of Things (IoT) sensor set 525), and network module 565. Remote server 504 includes remote database 560. Public cloud 505 includes gateway 540, cloud orchestration module 541, host physical machine set 542, virtual machine set 543, and container set 544.

Computer 501 may take the form of a desktop computer, laptop computer, tablet computer, smartphone, smartwatch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically Computer 501, to keep the presentation as simple as possible. Computer 501 may be located in a cloud, even though it is not shown in a cloud in FIG. 5. On the other hand, Computer 501 is not required to be in a cloud except to any extent as may be affirmatively indicated.

Processor set 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto Computer 501 to cause a series of operational steps to be performed by processor set 510 of Computer 501 and thereby effect a computer-implemented method, such that the instructions thus executed instantiates the methods specified in flowcharts and/or narrative descriptions of computer-implemented methods included in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 500, at least some of the instructions for performing the inventive methods may be stored in storage 513.

Communication fabric 511 is the signal conduction path that allows the various components of Computer 501 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

Volatile memory 512 is any type of volatile memory now known or to be developed in the future. Examples include dynamic type random access memory (RAM) or static type RAM. Typically, volatile memory 512 is characterized by random access, but this is not required unless affirmatively indicated. In Computer 501, the volatile memory 512 is located in a single package and is internal to Computer 501, but, alternatively or additionally, the volatile memory may be distributed over multiple packages and/or located externally with respect to Computer 501.

Storage 513 is any form of storage for computers that is now known or to be developed in the future. Storage 513 may include a crossbar of an SRAM, PCM, and/or a ReRam.Typically at least a portion of the storage 513 allows writing of data, deletion of data and re-writing of data. Operating system 522 may take several forms, such as various known proprietary operating systems or open-source Portable Operating System Interface-type operating systems that employ a kernel. The code included in the storage 513 typically includes at least some of the computer code involved in performing the inventive methods.

Peripheral device set 514 includes the set of peripheral devices of Computer 501. Data communication connections between the peripheral devices and the other components of Computer 501 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. External storage 524 may include, but is not limited to an external hard drive, or insertable storage, such as an SD card. External storage 524 may be persistent and/or volatile. In some embodiments, the external storage 524 may take the form of a quantum computing storage device for storing data in the form of qubits. In embodiments where Computer 501 is required to have a large amount of storage (for example, where Computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

Network module 515 is the collection of computer software, hardware, and firmware that allows Computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer readable program instructions for performing the inventive methods can typically be downloaded to Computer 501 from an external computer or external storage device through a network adapter card or network interface included in network module 515.

WAN 502 is any wide area network (for example, the internet) capable of communicating computer data over non-local distances by any technology for communicating computer data, now known or to be developed in the future. In some embodiments, the WAN 502 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 503 is any computer system that is used and controlled by an end user (for example, a customer of an enterprise that operates Computer 501) and may take any of the forms discussed above in connection with Computer 501. EUD 503 typically receives helpful and useful data from the operations of Computer 501. For example, in a hypothetical case where Computer 501 is designed to provide a recommendation to an end user, this recommendation would typically be communicated from network module 515 of Computer 501 through WAN 502 to EUD 503. In this way, EUD 503 can display, or otherwise present, the recommendation to an end user. In some embodiments, EUD 503 may be a client device, such as a thin client, heavy client, mainframe computer, desktop computer and so on.

Remote server 504 is any computer system that serves at least some data and/or functionality to Computer 501. Remote server 504 may be controlled and used by the same entity that operates Computer 501. Remote server 504 represents the machine(s) that collect and store helpful and useful data for use by other computers, such as Computer 501. For example, in a hypothetical case where Computer 501 is designed and programmed to provide a recommendation based on historical data, then this historical data may be provided to Computer 501 from remote database 530 of remote server 504.

Public cloud 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

### CONCLUSION

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to better explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications, and variations that fall within the true scope of the present teachings.

The components, operations, steps, features, objects, benefits, and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any such actual relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, the inventive subject matter lies in less than all features of a single disclosed embodiment. Thus, the following claims are hereby incorporated into the Detailed Description, with each claim standing on its own as a separately claimed subject matter.

What is claimed is:

1. A computer-implemented method of performing digital post-processing of an in-memory computing crossbar array, the method comprising:
providing a digital computing block positioned at a periphery of the in-memory computing crossbar array, wherein the digital computing block is configured to:
perform fixed-point computations of an input;
perform compression on the fixed-point computations of the input; and
perform a nonlinear activation function.

2. The computer-implemented method according to claim 1, further comprising performing a plurality of the fixed-point computations in parallel on respective outputs of the in-memory computing crossbar array.

3. The computer-implemented method according to claim 1, further comprising performing affine scale and offset correction using the fixed-point computations.

4. The computer-implemented method according to claim 1, wherein providing the digital computing block is customized based on different sizes of the input, different sizes of an affine scale and offset correction including integer precision and fractional precision, and different sizes of fixed-point compression parameters regarding a number of bits to cut before and after rounding.

5. The computer-implemented method according to claim 1, further comprising parameterizing the digital computing block to process one entry of the input at a time as an N-bit unsigned input or a signed input by a crossbar of the in-memory computing crossbar array, wherein N is a number of data bits.

6. The computer-implemented method according to claim 5, wherein providing the digital computing block includes providing a plurality of sub-blocks configured to perform operations including multiplication, addition, shifting, and fixed-point quantization.

7. The computer-implemented method according to claim 6, wherein multiplication operations are performed by a multiplier sub-block by applying a scale parameter to the N-bit unsigned input or signed input and outputting a high-precision number including N+X bits for an integer part and Y bits for a fractional part, and wherein high-precision of a shifted value substantially matches an expected outcome.

8. The computer-implemented method according to claim 7, wherein shifting operations are performed by a shifting sub-block that verifies an output of the multiplier sub-block fits a desired precision with regard to a number of bits.

9. The computer-implemented method according to claim 8, wherein fixed-point quantization operations are performed by a fixed-point quantization sub-block that reduces a precision of data output by the shifting sub-block.

10. The computer-implemented method according to claim 9, wherein the fixed-point quantization sub-block is configured to reduce the precision of data output by the shifting sub-block by cutting one or more least significant bits (LSB) and/or one or more most significant bits (MSB).

11. The computer-implemented method according to claim 10, wherein the fixed-point quantization sub-block is additionally configured to minimize a precision loss of data output by the shifting sub-block, to perform a cut and round operation, and to check for an overflow after the cut and round operation.

12. The computer-implemented method according to claim 11, further comprising generating a signed output of the fixed-point quantization sub-block by performing a 2's complement operation.

13. The computer-implemented method according to claim 1, wherein providing the digital computing block is based on:
defining a search space by creating a parametric model of the digital computing block;
configuring, with a chip simulator, the digital computing block with regards to a bit-size of parameters of inputs and a fixed-point quantization operation;
iteratively evaluating configurations of the defined search space, and evaluating a performance of one or more configurations in terms of accuracy;
synthesizing the one or more configurations having a highest ranked accuracy; and
selecting the digital computing block fitting design constraints of the one or more configurations and/or by performance in terms of energy efficiency.

14. A computer-implemented method of performing digital post-processing of a near-in-memory computing logic, the method comprising:
processing one or more entries across a plurality of clock cycles, wherein each entry comprises two multi-bit unsigned integers corresponding to positive and negative outputs of an Analog-to-Digital (ADC) converter;
multiplying the two multi-bit unsigned integers in parallel with a scale parameter;
performing a shifting operation of an output of each multiplied two multi-bit unsigned integers and determining whether the output of each multiplied two multi-bit unsigned integers fits a desired precision;
performing an overflow check to verify whether there is an overflow after the multiplying of the two multi-bit unsigned integers to determine whether a result of the multiplying is saturated to a maximum representable value with a specified precision; and
performing a fixed-point compression algorithm to reduce a size of the result of the multiplying, and an offset operation.

15. The computer-implemented method according to claim 14, wherein the processing of one or more entries is time-multiplexed across a plurality of clock cycles, and wherein the performing of the fixed-point compression algorithm comprises:
truncating one or more of a most significant bit (MSB) and one or more of a least significant bit (LSB); checking a value of a round bit;
upon determining the value of the round bit is 0, truncating the MSB and LSB bits without rounding; and
upon determining the value of the round bit is 1, rounding up prior to truncating the MSB and LSB bits.

16. A digital computing block for in-memory computing, the digital computing block comprising:
a multiplier sub-block configured to apply a scale parameter to an N-bit unsigned input;
a shifting sub-block configured to shift operations that verify an output of the multiplier sub-block fits a desired precision with regard to a number of bits;
an adder sub-block configured to perform offset operations; and
a fixed-point quantization sub-block configured to reduce the number of bits and minimize a precision loss of an output of the shifting sub-block by a cut and round operation,
wherein the digital computing block is positioned at a periphery of an in-memory computing crossbar array.

17. The digital computing block according to claim 16, wherein the fixed-point quantization sub-block is configured to
perform fixed-point computations of an input;
perform compression on the fixed-point computations of the input; and
perform a nonlinear activation function.

18. The digital computing block according to claim 16, wherein the digital computing block is customized based on different sizes of an input, different sizes of an affine scale and offset correction including integer precision and fractional precision, and different sizes of fixed-point compression parameters regarding a number of bits to cut before and after rounding.

19. The digital computing block according to claim 16, wherein the fixed-point quantization sub-block is configured to reduce the precision loss of data output by the shifting sub-block by cutting one or more least significant bits (LSB) and/or one or more most significant bits (MSB).

20. The digital computing block according to claim 16, further configured to perform a plurality of a fixed-point computations in parallel on respective outputs of the in-memory computing crossbar array.
